(19) United States
(12) Patent Application Publication
(10) Pub. No.: US 2008/0199153 A1
(43) Pub. Date: Aug. 21, 2008

(54) Coding and Decoding Method and Device for Improving Video Error Concealment

(75) Inventors: Jin Wang, Shanghai (CN); Daqing Zhang, Shanghai (CN); Jiagang Zhang, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/917,223

(22) PCT Filed: Jun. 9, 2006
(86) PCT No.: PCT/IB2006/051835

§ 371 Date: Dec. 12, 2007

(30) Foreign Application Priority Data
Jun. 17, 2005 (CN) 200510077545.3

(51) Int. Cl. H04N 7/26; H04N 7/68

(52) U.S. Cl. 386/109; 386/113

(57) ABSTRACT

A coding and decoding method and device for improving video error concealment is disclosed in the present invention. The coding method includes the steps of: obtaining a macro block smoothness information of a macro block in a video stream, which indicates whether the boundaries of the macro block are smooth or not; and coding the macro block smoothness information into a coded video stream. The decoding method includes the steps of: determining whether the boundaries of a lost macro block are smooth or not according to the macro block smoothness information of the lost macro block in a video stream; smoothing the displacing macro block for the lost macro block if the boundaries are smooth. The smoothed displacing macro block is more similar to the original macro block, thereby the whole image is more natural with a small coding cost but a highly improved image quality; further, the calculation amount thereof is small, and the cost to realize it is relatively low.

### FIELD OF THE INVENTION

The present invention relates to a method and device of video coding and decoding, and particularly to a coding and decoding method and device for improving video error concealment.

### BACKGROUND OF THE INVENTION

In digital television (SDTV/HDTV) and multimedia applications, there are many video compression standards, such as MPEG (Motion Picture Experts Group), H.263 or Quicktime standard, to satisfy different requirements. The main object of these standards is to realize a video stream having a lower bit rate and better quality after compression. However, due to the individual or impulse bit errors (i.e., bit-stream errors) in a coded video stream, the synchronization of the decoding device usually fails, such that the decoding cannot be carried out until the next synchronization point is reached, leading to the deformation of part of the image.

One possible way to avoid such undesired image deformation is to cover these deformed parts on the decoded image by using an error concealment technique in the decoding device. However, the effect of the error concealment technique in the decoding device is limited.

A class of error concealment techniques are disclosed in “Error control and concealment for video communication: A review,” by Y. Wang and Q.-F. Zhu, Proc. WEE, vol. 86, no. 5, pp. 975-775, May 1998. Said class of error concealment techniques include the method of improving the error recoverability of the coded video stream by adding redundancies in the coding device. However, said class of error concealment methods require adjusting the coding device and increasing greatly the additional information of the bit stream. Moreover, since the conventional video coding device has less consideration for the post-treatment of the error concealment, it is hard to achieve a satisfactory image quality through the above error concealment techniques.

When performing error concealment in the conventional video decoding device, if a macro block is lost in successive macro blocks, the decoding device will create a motion vector and replace the lost macro block with the area directed by the motion vector in the reference image, thus completing the error concealment. However, in many cases, the variation between the boundaries of the displacing macro block for the lost macro block and the boundaries of other macro blocks around the lost macro block is great, such that the displacing macro block is rather distinct in the whole image, which significantly influences the effect of error concealment. Therefore, how to solve the problem of the obvious boundaries of the displacing macro block becomes the focus.

### OBJECT AND SUMMARY OF THE INVENTION

The present invention provides an improved coding and decoding method and device for error concealment, which can be used to make the displacing macro block more similar to the lost original macro block after the lost macro block has been replaced by the displacing macro block, so as to produce a more natural image as a whole.

According to one embodiment of the present invention, a coding method for improving video error concealment is provided, which comprises the steps of: obtaining a macro block smoothness information of a macro block in a video stream, which indicates whether the boundaries of the macro block are smooth or not; coding the macro block smoothness information into a coded video stream.

According to another embodiment of the present invention, a decoding method for improving video error concealment is further provided, which comprises the steps of: determining whether the boundaries of a lost macro block are smooth or not according to the macro block smoothness information of the lost macro block in the video stream; and smoothing a displacing macro block for the lost macro block if the boundaries are smooth.

According to yet another embodiment of the present invention, a coding device is provided, which comprises: an obtaining device for obtaining a macro block smoothness information of a macro block in a video stream which indicates whether the boundaries of the macro block are smooth or not; and a writing device for coding the macro block smoothness information into a coded video stream.

According to yet another embodiment of the present invention, a decoding device is provided, which comprises: a determining device for determining whether the boundaries of a lost macro block are smooth or not according to the macro block smoothness information of the lost macro block in a video stream; and a smoothing device for smoothing a displacing macro block for the lost macro block if the boundaries are smooth.

According to the embodiments of the present invention, the smoothed displacing macro block is more similar to the original macro block, so that the whole image is mole natural with a little coding cost but a highly improved image quality; further, the calculation amount thereof is small, and the cost to realize it is relatively low. Moreover, few modifications on the hardware are needed, and thus the cost is relatively low.

Other objects and achievements of the present invention will be apparent and fully understood with reference to the accompanying drawings, the description and the claims.

### BRIEF DESCRIPTION OF THE DRAWINGS

FIG. 1 depicts a flow chair of a coding method for improving error concealment according to an embodiment of the present invention;

FIG. 2 depicts a schematic view of the syntactic structure of an MPEG coding image;

FIG. 3 depicts a schematic view of the syntactic structure of an MPEG coding image according to an embodiment of the present invention;

FIG. 4 depicts a schematic view of coding 1-bit-long macro block smoothness information into the slice header section according to an embodiment of the present invention;

FIG. 5 depicts a flow chart of a decoding method for processing error concealment boundaries according to an embodiment of the present invention;

FIG. 6 depicts a schematic view of a smoothing process of the macro block boundaries according to an embodiment of the present invention;

FIG. 7 depicts a structural diagram of a coding device according to an embodiment of the present invention;

FIG. 8 depicts a structural diagram of a decoding device according to an embodiment of the present invention.

Identical reference numerals represent the same, similar or corresponding features or functions throughout the drawings.

### DETAILED DESCRIPTION OF THE INVENTION

The present invention provides an improved error concealment approach, which processes the boundaries of the displacing macro block after the lost macro block has been replaced by the displacing macro block, using the macro block boundary smoothness information coded into the slice header when coding, so that the displacing macro block is more similar to the lost original macro block, and the whole image is more natural.

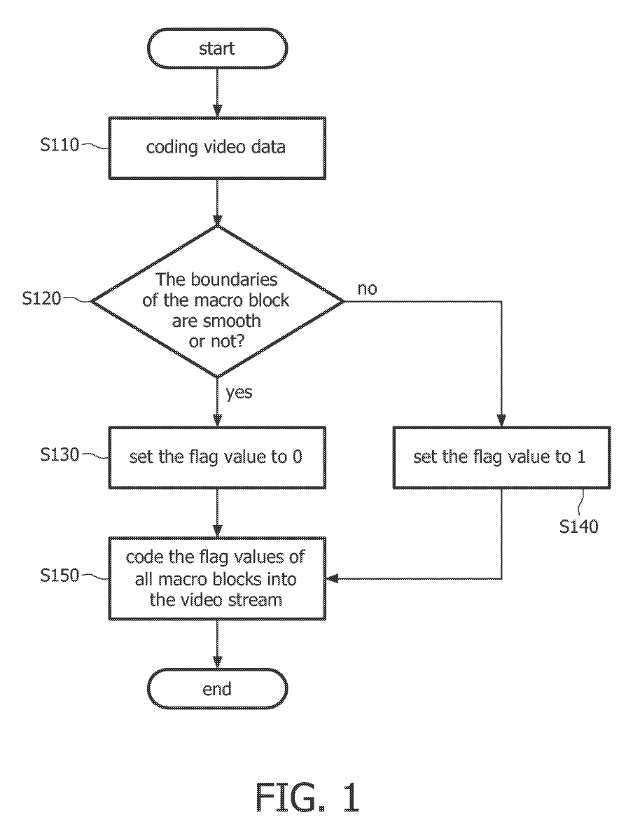

FIG. 1 depicts a flow chair of a coding method for improving error concealment according to an embodiment of the present invention, wherein the coded video stream actually includes the macro block smoothness information indicating whether the boundaries of all the coded macro blocks and the boundaries of their adjacent macro blocks are smooth or not.

In step S110, video data is coded according to a pre-set standard (e.g., MPEG, H.263 or Quicktime standard). For example, in MPEG, the whole image is divided into multiple N×N pixel blocks each of the N×N pixel blocks is DCT (Discrete Cosine Transform) transformed one by one, and then quantization and variable length coding are carried out.

When coding each image, if the variable length coding is carried out, in step S120, each macro block is compared with the adjacent macro blocks to determine whether its boundaries are smooth or not. Thereafter, the information about whether the macro block is smooth or not is obtained according to the determination. For example, in the embodiment as shown in FIG. 1, in step S130, if the boundaries of the macro block are smooth, set the flag value to 0, otherwise, in step S140, set the flag value to 1. Then, in step S150, these flag values, i.e. the information indicating whether the boundaries of the macro block are smooth or not, are coded into the coded video stream.

According to an embodiment of the present invention, the macro block smoothness information indicating whether the four boundaries of each macro block are smooth or not is 1-bit-long flag value. The flag value can be 0 or 1. Since the boundaries of most successive macro blocks are successive, according to an embodiment of the present invention, it can be defined that when the flag value is 0, it indicates that three or four boundaries of the macro block are smooth, when the flag value is 1, it indicates that one or two boundaries of the macro block are smooth, thereby improving the coding efficiency.

It is obvious that other flag values can also be used to characterize whether the boundaries of the macro block are smooth or not. For example, the flag value can be 2 bits, which can be 00, 01, 10 and 11, wherein 00 indicates that four boundaries of the macro block are all smooth, 11 indicates that four boundaries are not smooth, while 01 indicates that the left and right boundaries are not smooth, and 10 indicates that the upper and bottom boundaries are not smooth. The longer the flag value is, the lower the coding efficiency is. Therefore, generally, for the boundary processing of the displacing macro block, 1-bit-long flag value will be enough.

According to an embodiment of the present invention, whether the boundaries of the macro block are smooth or not can be determined with the discrete cosine transform coefficient of the macro block. If the difference between two DCT coefficients corresponding to adjacent macro blocks is larger than a predetermined threshold value, it indicates that the smoothness and uniformity between the two successive macro blocks are relatively low, and the boundaries are not smooth. At this time, the flag value is set to 1; otherwise, the flag value is set directly to 0.

A macro block (16×16 pixels) includes 4 DCT blocks (8×8 pixels), and a DCT block includes 64 coefficients. Since the high-frequency components of most images are relatively low, the coefficient corresponding to the high-frequency component of the image tends to be zero. Furthermore, since the human eye is not very sensitive to the distortion of the high-frequency component, a rougher quantification can be used; therefore, the digital rate used for transporting the transform coefficient is much less than the digital rate used for transporting image pixels. Depending on the requirements of the calculation amount and the image quality, the determination may be made with only a first DCT coefficient, or with the previous 10 DCT coefficients of low frequency.

According to another embodiment of the present invention, the determination can also be made directly in the pixel domain without using the DCT coefficients. For example, the pixel values of the boundary areas of adjacent macro blocks are analyzed, taking the difference between the pixel values of the boundary areas of adjacent macro blocks as the criterion of determination. Assuming that P0 . . . P15 and p0 . . . p15 represent the lightness components of pixel values in the boundary areas of adjacent macro blocks respectively, if

$${\sum }_{i = 0}^{15} \vert {P}_{i} - {p}_{i} \vert$$

is less than 32, it can be determined that the boundaries are smooth; otherwise, the boundaries are not smooth.

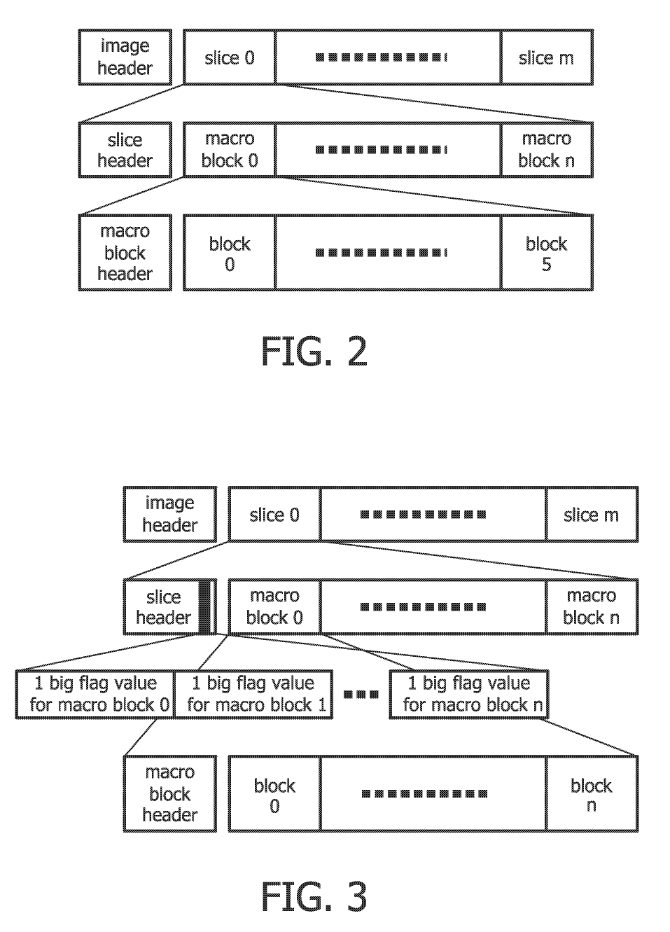

Hereinafter, the process of how to code the macro block smoothness information into the video stream in a coding device will be illustrated by taking the MPEG as an example. FIG. 2 is a schematic view of the syntactic structure of a common MPEG coding image. As shown in FIG. 2, besides the macro blocks which are fully video information, each image further includes an image header section, a slice header section and a macro block header section.

As shown in FIG. 3, according to an embodiment of the present invention, the information indicating whether all macro blocks in a slice are smooth or not is coded into the slice header information of each slice. According to MPEG standard, the slice header section further includes a retained field for coding other information as desired, in addition to the necessary information defined by the standard. In the present embodiment, the retained field is used to code the macro block smoothness information, indicating whether the four boundaries of each macro block in the slice are smooth or not, into the video stream.

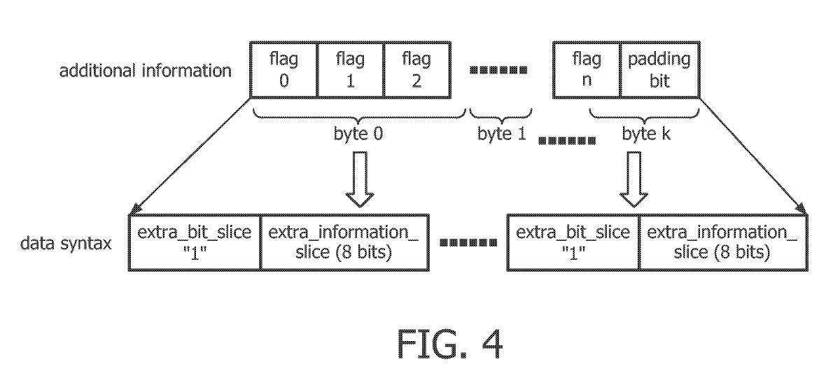

FIG. 4 depicts a schematic view of coding 1-bit-long macro block smoothness information into the slice header section. All of the macro block smoothness information forms a binary sequence, wherein every 8 bits constitute a byte to form an extra-information slice, and the last byte with less than 8 bits is completed with padding bits (such as 0). For example, a slice including 45 macro blocks each corresponding to 1-bit-long macro block smoothness information, i.e., 45 bits, can be supplemented with 3 padding bits (such as 0), to form 48 bits, thereby up to a total of 6 bytes. Then, it is coded into the slice header information according to the syntax of MPEG. Refer to relevant standards of MPEG for the extra-information slice and related syntax.

How to accommodate the corresponding macro block smoothness information into a video stream has been illustrated above with reference to a specific MPEG standard for illustration. Of course, in the above embodiment, the macro block smoothness information can also be coded into either the image header section or the macro block header section. However, due to the limitation of the standard itself and the fact that the macro block header section might get lost with the macro block simultaneously, the macro block smoothness information is generally coded into the slice header section for MPEG standard. For other video compression standards with different syntaxes and related requirements, e.g., H.263 or Quicktime, the macro block smoothness information can be coded into different positions in the video stream according to different standards.

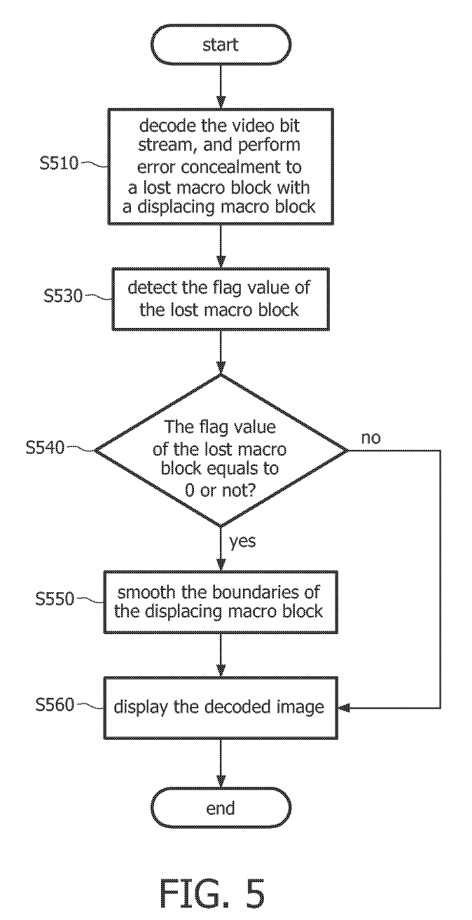

FIG. 5 depicts a flow chart of video decoding according to an embodiment of the present invention, wherein the boundaries of the displacing macro block are smoothed according to the macro block smoothness information in the video stream, based on the conventional error concealment scheme.

In step S510, the compressed video data is decoded according to the pre-set standard, the macro block smoothness information can be obtained after VLD decoding the compressed video stream, and error concealment is performed. For example, if a macro block is lost, the decoding device will create a motion vector, and the lost macro block will be replaced by the area (displacing macro block) directed by the motion vector in the image.

In step S530, the macro block smoothness information is obtained from the video stream, and the flag value of the lost macro block is checked: if the flag value is set to 0, it indicates that the boundaries of the macro block are smooth. In step S540, whether the flag value of the lost macro block is 0 or not is determined, that is, whether the boundaries of the lost original macro block in the position of the displacing macro block are smooth or not is determined. If the flag value is 0, the boundaries of the displacing macro block in the video image sequence subject to inverse quantification (IQ) and inverse discrete cosine transform (IDCT) are smoothed in step S550. Otherwise, if the boundaries of the macro block are not smooth, i.e., if the flag value is set to 1, proceed to step S560 directly. In step 560, all macro blocks, smoothed or not, are received to form a new decoded image.

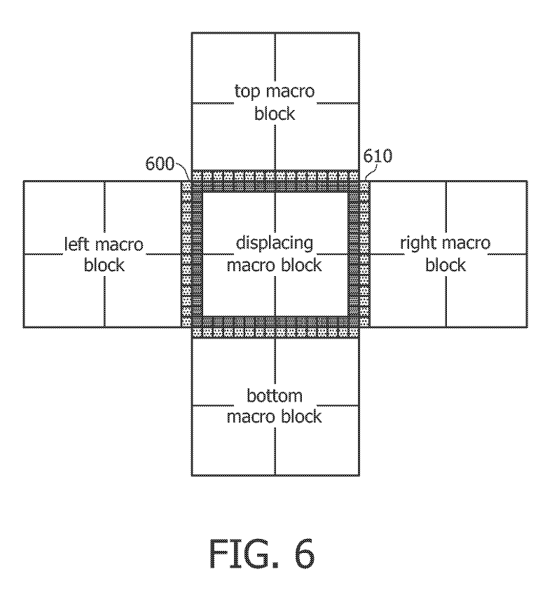

FIG. 6 depicts a schematic view of smoothing the boundaries of the macro block according to an embodiment of the present invention. As shown in FIG. 6, the boundary pixels 600 of the displacing macro block are smoothed according to the macro blocks around the displacing macro block, e.g., the top macro block, the bottom macro block, the left macro block and the right macro block. The smoothing process causes filter interpolation to the adjacent pixels at the boundary. Different filter coefficients are employed in different processes.

With reference to FIG. 6, according to an embodiment of the present invention, the smoothing process is to replace the boundary pixels 600 of the original displacing macro block with the average value of the boundary pixels 600 of the displacing macro block and the boundary pixel 610 of the adjacent macro blocks. For example, if the lightness of a boundary pixel of the displacing macro block is 30, and the lightness of the adjacent boundary pixel of the macro block is 70, the average value 50 of the two is used to replace the boundary pixel of the original displacing macro block. Thus, the lightness value of the pixel in the displacing macro block adjacent to the pixel with a lightness of 70 in the macro blocks turns to 50. Thus, the smoothness of the boundary is increased, the displacing macro block is more similar to the lost macro block, and the effect of error concealment is further enhanced. Since the human eye is sensitive to the lightness signal but is less sensitive to the chroma signal, the lightness signal Y only needs to be smoothed, while the other two chromatism signals U, V may not be compared and smoothed.

According to the embodiments of the present invention, the smoothing process of the boundaries of the macro block can be achieved by the weighted averaging of the pixels in the displacing macro block and those out of the displacing macro block. Alternatively, the averaging algorithm involves more pixels in the displacing macro block and those out of the displacing macro block.

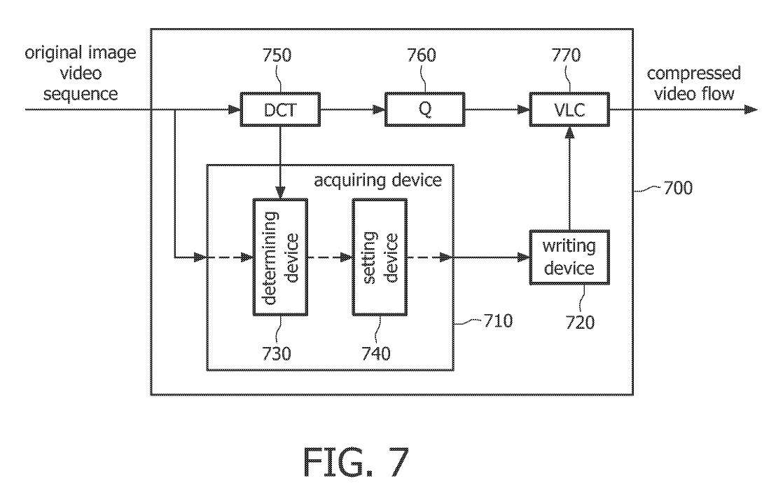

FIG. 7 depicts a structural diagram of a coding device according to an embodiment of the present invention. The coding device 700 includes an obtaining device 710 and a writing device 720. The obtaining device 710 is used for obtaining from the original video sequence the macro block smoothness information indicating whether the boundaries of each macro block are smooth or not. The writing device 720 is used for coding said macro block smoothness information into the coded video stream.

According to an embodiment of the present invention, the obtaining device 710 may further include a determining device 730, and may also include a setting device 740. With reference to the dashed line in FIG. 7, after completing the coding of each image according to the pre-set standard, the determining device 730 compares each macro block with the adjacent macro blocks to determine if its boundaries are smooth or not; and the macro block smoothness information indicating whether the macro block is smooth or not is obtained according to the determination. The determining device 730 determines whether the boundaries of the macro block are smooth or not by using the DCT coefficient of the macro block or the pixel domain analysis of the macro block or other approaches, as have been described above in detail, and will not be repeated herein.

The setting device 740 can be used for setting the macro block smoothness information according to the determination as to whether the boundaries of the macro block are smooth or not from the determining device 730. For example, the macro block smoothness information can be 1-bit-long flag value: if the boundaries of the macro block are smooth, the flag value is set to 0; otherwise, the flag value will be set to 1. Then, according to an embodiment of the present invention, the writing device 720 codes all the flag values, i.e. the information indicating whether the boundaries of the macro block are smooth or not, into the video stream, e.g., successively coding the macro block smoothness information of all macro blocks included in each slice of the video stream into the slice header section of said slice, to finish the coding of the image.

The coding device 700 further includes a discrete cosine transform device (DCT as shown) 750, a quantizer (Q as shown) and a variable length coding device (VLC as shown) 770, wherein the discrete cosine transform device 750 is used to receive the original video image sequence, perform discrete cosine transform, and transport the DCT coefficient of each macro block to the determining device 730.

The quantizer 760 is used for setting different quantification levels for the obtained DCT coefficients according to different requirements, thereby reducing the digital rate. But after quantification, especially after setting different quantifications to low-frequency components and high-frequency components according to the physiological characteristic of the human eyes, the coefficient of most high-frequency components will become zero. Generally, the human eyes are relatively more sensitive to the low-frequency components, but less sensitive to the high-frequency components. Therefore, a finer quantification is carried out for the low-frequency components, while a rougher quantification is carried out for the high-frequency components.

The variable length coding device 770 transforms the quantification coefficient from the quantizer into variable length codes (e.g., Huffman codes) according to the quantification magnitude provided by the quantizer 760, thereby decreasing the code rate. Meanwhile, the writing device 720 writes said macro block smoothness information into the compressed video stream. It should be understood for those skilled in the art that the writing device 770 may also be included in the variable length coding device 770.

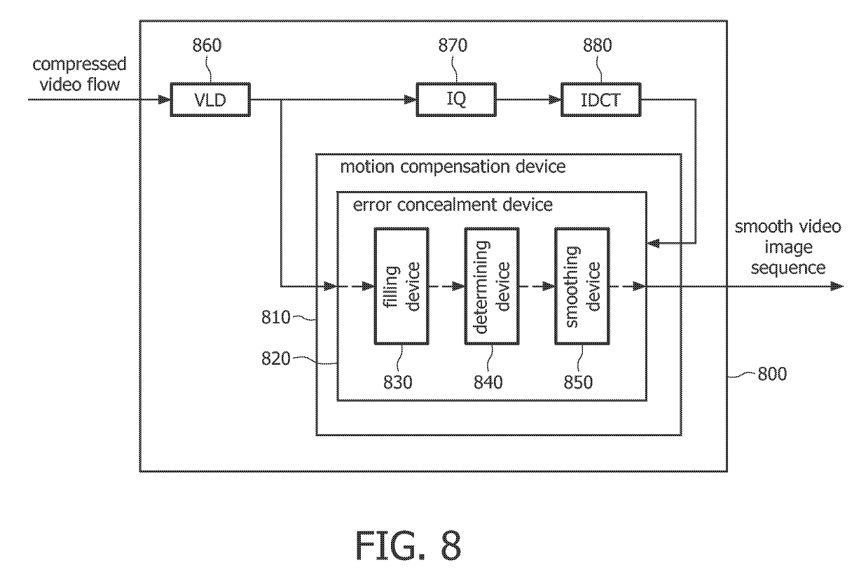

FIG. 8 depicts a structural diagram of a decoding device according to an embodiment of the present invention. The decoding device 800 includes a motion compensation device 810, for reducing the spatial redundancy with the spatial correlation between the frames. Since the motion compensation is not the key point of the present invention, the related details of the motion compensation technique will not be described herein.

The motion compensation device 810 includes an error concealment device 820 used for determining the displacing macro block. For example, if a macro block is lost, the error concealment device 820 will conduct the error concealment by creating a motion vector, and displacing the lost macro block with the area directed by the motion vector in the reference image.

The error concealment device 820 includes a filling device 830, for displacing the lost macro block with a displacing macro block and a determining device 840, for determining if the boundaries of the original lost macro block are smooth or not according to the obtained macro block smoothness information of the lost macro block.

The error concealment device 820 may further include a smoothing device 850, for smoothing the boundaries of the displacing macro block. If the boundaries of the lost macro block are smooth, the boundaries of the displacing macro block will be smoothed by the smoothing device 850. If the boundaries of the lost macro block are not smooth, no processing may be needed for the displacing macro block. The smoothing device 850 may include a filter (not shown), for smoothing the boundaries of the displacing macro block by filter interpolating the boundary pixels or by other means. This has been described above in detail, and will not be repeated herein.

The decoding device 800 further includes a variable length decoding device (VLD) 860, an inverse quantizer (IQ) 870 and an inverse discrete cosine transform device (IDCT) 880. The decoding functions correspond to the variable length coding device 770, the quantizer 760 and the discrete cosine transform device 750 of the coding device 700 in FIG. 7, and will not be repeated herein. After the compressed video stream is decoded by the variable length decoding device 860, the determining device 830 obtains the macro block smoothness information, to determine whether the boundaries of the original lost macro block are smooth or not. If the boundaries are smooth, the smoothing device 850 smoothes the video image sequence subject to inverse quantification and inverse discrete cosine transform, and finally a smooth video image sequence is outputted, and presented to the user by a display device (not shown).

While the technical contents and features of the present invention are disclosed as above, various alternations and modifications can be made by those skilled in the art based on the teachings and disclosures of the present invention without departing from the spirit of the present invention. Therefore, the protective scope of the present invention shall not be limited to the disclosure of the embodiments, but also includes said various alternations and modifications, as is defined by the following claims.

1. A coding method for improving video error concealment, comprising:
obtaining a macro block smoothness information of a macro block in a video stream, which indicates whether the boundaries of said macro block are smooth; and
coding said macro block smoothness information into a coded video stream.

2. The method as claimed in claim 1, wherein said macro block smoothness information is a 1 bit flag value.

3. The method as claimed in claim 2, further comprising setting said flag value to 0 if said macro block boundaries are smooth, and setting said flag value to 1 if said macro block boundaries are not smooth.

4. The method as claimed in claim 1, further comprising determining whether said boundaries of said macro block are smooth based on the discrete cosine transform (DCT) coefficients of said macro block and its adjacent macro blocks.

5. The method as claimed in claim 1, further comprising determining whether said boundaries of said macro block are smooth based on the pixel domain analysis to said macro block and its adjacent macro blocks.

6. The method as claimed in claim 1, further comprising coding said macro block smoothness information into the slice header section of a slice containing said macro block.

7. A decoding method for improving video error concealment, comprising:
determining whether the boundaries of a lost macro block are smooth according to the macro block smoothness information of said lost macro block in a video stream; and
if said boundaries are smooth, smoothing a displacing macro block for said lost macro block.

8. The method as claimed in claim 7, further comprising filling said displacing macro block to the position of said lost macro block.

9. The method as claimed in claim 7, further comprising obtaining said macro block smoothness information.

10. The decoding method as claimed in claim 7, wherein the smoothing comprises filter interpolating the adjacent pixels at the boundaries of said displacing macro block.

11. The decoding method as claimed in claim 7, wherein the smoothing comprises displacing a boundary pixel of said displacing macro block with the average value of the boundary pixel of said displacing macro block and the boundary pixels of the macro blocks around said displacing macro block.

12. A coding device, comprising:
an obtaining device for obtaining a macro block smoothness information of a macro block in a video stream, said macro block smoothness information indicating whether the boundaries of said macro block are smooth; and
a writing device for coding said macro block smoothness information into a coded video stream.

13. The device as claimed in claim 12, wherein said macro block smoothness information is a 1 bit flag value.

14. The device as claimed in claim 13, wherein said obtaining device comprises a setting device for setting said flag value to 0 if said macro block boundaries are smooth, and setting said flag value to 1 if said macro block boundaries are not smooth.

15. The device as claimed in claim 12, wherein said obtaining device comprises a determining device for determining whether the boundaries of said macro block are smooth based on the discrete cosine transform (DCT) coefficients of said macro block and its adjacent macro blocks.

16. The device as claimed in claim 12, wherein said obtaining device comprises a determining device for determining whether the boundaries of said macro block are smooth based on the pixel domain analysis to said macro block and its adjacent macro blocks.

17. The device as claimed in claim 12, wherein said writing device is used for coding said macro block smoothness information into the slice header section of a slice containing said macro block.

18. A decoding device, comprising:
a determining device for determining whether the boundaries of a lost macro block are smooth according to the macro block smoothness information of said lost macro block in a video stream; and
a smoothing device for smoothing a displacing macro block for said lost macro block if said boundaries are smooth.

19. The device as claimed in claim 18, further comprising a filling device for filling said displacing macro block to the position of said lost macro block.

20. The device as claimed in claim 18, wherein said smoothing device is used for filter interpolating the adjacent pixels at the boundaries of said displacing macro block.

21. The device as claimed in claim 18, wherein said smoothing device is used for substituting a boundary pixel of said displacing macro block with the average value of the boundary pixel of said displacing macro block and the boundary pixels of the macro blocks around said displacing macro block.
